(19) United States
(12) Patent Application Publication
(10) Pub. No.: US 2018/0274436 A1
(43) Pub. Date: Sep. 27, 2018

(54) METHODS AND SYSTEMS FOR AN ENGINE START USING AN ELECTRICALLY DRIVABLE COMPRESSOR

(71) Applicant: Ford Global Technologies, LLC, Dearborn, MI (US)

(72) Inventors: Joerg Kemmerling, Monschau (DE); Vanco Smiljanovski, Bedburg (DE); Hanno Friederichs, Aachen (DE); Helmut Matthias Kindl, Aachen (DE); Arnd Sommerhoff, Aachen (DE); Andreas Kuske, Geulle (NL); Frank Wunderlich, Herzogenrath (DE); Michael Forsting, Moenchengladbach (DE)

(21) Appl. No.: 15/914,751

(22) Filed: Mar. 7, 2018

(30) Foreign Application Priority Data
Mar. 24, 2017 (DE) 102017205044.6

(51) Int. Cl. F02B 37/14; F02B 37/16; F02B 37/11; F02B 37/013

(52) U.S. Cl. CPC F02B 37/14; F02B 37/013; F02B 37/11; F02B 37/16

(57) ABSTRACT

Methods and systems are provided for expediting turbine spool up during an engine restart following an engine stop while a vehicle is in motion. In one example, a method includes, in response to engine restart conditions being met, operating an electrically driven compressor to supply compressed air to a turbocharger turbine for expedited turbine spool up during engine cranking.

### CROSS REFERENCE TO RELATED APPLICATION

The present application claims priority to German Patent Application No. 102017205044.6, filed Mar. 24, 2017. The entire contents of the above-referenced application are hereby incorporated by reference in its entirety for all purposes.

### FIELD

The present description relates generally to system and methods for operating a supercharged internal combustion engine including an electrically drivable compressor for turbocharger turbine spool up during engine start stop conditions.

### BACKGROUND/SUMMARY

An internal combustion engine is used as a motor vehicle drive unit. Herein, the expression “internal combustion engine” encompasses diesel engines, Otto-cycle engines, and hybrid internal combustion engines, that is to say internal combustion engines that are operated using a hybrid combustion process, and hybrid drives which comprise not only the internal combustion engine but also an electric machine which can be connected in terms of drive to the internal combustion engine and which receives power from the internal combustion engine or which, as an activatable auxiliary drive, additionally outputs power.

Internal combustion engines are ever more commonly being equipped with a supercharging arrangement, wherein supercharging is primarily a method for increasing power, in which the charge air required for the combustion process in the engine is compressed, as a result of which a greater mass of charge air can be supplied to each cylinder per working cycle. In this way, the fuel mass and therefore the mean pressure can be increased.

Supercharging is a suitable means for increasing the power of an internal combustion engine while maintaining an unchanged swept volume, or for reducing the swept volume while maintaining the same power. In all cases, supercharging leads to an increase in volumetric power output and a more expedient power-to-weight ratio. If the swept volume is reduced, it is possible, given the same vehicle boundary conditions, to shift the load collective toward higher loads, at which the specific fuel consumption is lower. Supercharging of an internal combustion engine consequently assists in the efforts to minimize fuel consumption that is to say to improve the efficiency of the internal combustion engine.

By means of a suitable transmission configuration, it is additionally possible to realize so-called down speeding, whereby a lower specific fuel consumption is likewise achieved. In the case of down speeding, use is made of the fact that the specific fuel consumption at low engine speeds is generally lower, in particular in the presence of relatively high loads.

For supercharging, use is often made of an exhaust-gas turbocharger, in which a compressor and a turbine are arranged on the same shaft. The hot exhaust-gas flow is fed to the turbine and expands in the turbine with a release of energy, as a result of which the shaft is set in rotation. The energy supplied by the exhaust-gas flow to the shaft is used for driving the compressor which is likewise arranged on the shaft. The compressor delivers and compresses the charge air supplied to it, as a result of which supercharging of the at least one cylinder is obtained. A charge-air cooler is advantageously provided in the intake system downstream of the compressor, by means of which charge-air cooler the compressed charge air is cooled before it enters the at least one cylinder. The cooler lowers the temperature and thereby increases the density of the charge air, such that the cooler also contributes to improved charging of the cylinders, that is to say to a greater air mass. In effect, compression by cooling is obtained.

An advantage of an exhaust-gas turbocharger in relation to a supercharger, which can be driven by means of an auxiliary drive, is that an exhaust-gas turbocharger utilizes the exhaust-gas energy of the hot exhaust gases, whereas a supercharger draws the energy required for driving it directly or indirectly from the internal combustion engine and thus adversely affects, that is to say reduces, the efficiency, at least for as long as the drive energy does not originate from an energy recovery source.

If the supercharger is not one that can be driven by means of an electric machine, that is to say electrically, a mechanical or kinematic connection for power transmission is generally required between the supercharger and the internal combustion engine.

An advantage of a supercharger in relation to an exhaust-gas turbocharger is that the supercharger can generate, and make available, the required boost pressure at all times, specifically regardless of the operating state of the internal combustion engine, in particular regardless of the present rotational speed of the crankshaft. This applies in particular to a supercharger which can be driven electrically by means of an electric machine.

Difficulties may be encountered in achieving an increase in power in all engine speed ranges by means of exhaust-gas turbocharging. A relatively severe torque drop is observed in the event of a certain engine speed being undershot. Said torque drop is understandable if one takes into consideration that the boost pressure ratio is dependent on the turbine pressure ratio. If the engine speed is reduced, this leads to a smaller exhaust-gas mass flow and therefore to a lower turbine pressure ratio. Consequently, at lower engine speeds, the boost pressure ratio likewise decreases equating to a torque drop. It is sought to improve the torque characteristic of a supercharged internal combustion engine using various measures.

One such measure, for example, is a small design of the turbine cross section and simultaneous provision of an exhaust-gas blow-off facility. Such a turbine is also referred to as a waste-gate turbine. If the exhaust-gas mass flow exceeds a critical value, a part of the exhaust-gas flow is, within the course of the so-called exhaust-gas blow-off, conducted via a bypass line past the turbine. This approach has the disadvantage that the supercharging behaviour is inadequate at relatively high rotational speeds or in the presence of relatively high exhaust-gas flow rates.

The torque characteristic of a supercharged internal combustion engine may also be advantageously influenced by means of a plurality of exhaust-gas turbochargers connected in series. By connecting two exhaust-gas turbochargers in series, of which one exhaust-gas turbocharger serves as a high-pressure stage and one exhaust-gas turbocharger serves as a low-pressure stage, the engine characteristic map can advantageously be expanded, specifically both in the direction of smaller compressor flows and also in the direction of larger compressor flows.

The torque characteristic of a supercharged internal combustion engine may furthermore be improved by means of multiple turbochargers arranged in parallel, that is to say by means of multiple turbines of relatively small turbine cross section arranged in parallel, wherein turbines are activated successively with increasing exhaust-gas flow rate.

To comply with pollutant emissions limits and to further reduce fuel consumption, measures in addition to supercharging may be provided. One concept for reducing fuel consumption consists in switching off the internal combustion engine when there is no instantaneous power requirement or no instantaneous load demand, instead of continuing to operate the engine at idle (start-stop strategy). In practice, this means that the internal combustion engine is deactivated at least when the vehicle is at a standstill. One application is stop-and-go traffic, such as is encountered for example in traffic jams on freeways and highways. In inner-city traffic, stop-and-go traffic is no longer the exception but even the rule owing to the presence of non-inter coordinated traffic signals and the increased volume of traffic. Other applications are restricted rail crossings and, fundamentally, operating modes in which there is at least temporarily no load demand during driving.

A problem of the concepts that deactivate the internal combustion engine in the absence of demand in order to reduce fuel consumption is the need to restart the internal combustion engine. In the case of uncontrolled shutdown of the internal combustion engine, the crankshaft and the camshaft come to rest in an arbitrary, unknown position. The position of the pistons in the individual cylinders of the internal combustion engine is then unknown, and is left to chance. However, this information is essential for a restart that is uncomplicated and as rapid as possible and thus as fuel-saving as possible.

In order that the required information regarding the cylinder position is available upon the starting of the internal combustion engine, it is possible, upon the deactivation of the internal combustion engine, for the last position of the cylinder to be stored in the engine controller such that, upon the restart, a basis for the calculation of the ignition time and of the injection time is available even without the sensor signal from a camshaft sensor and/or from a crankshaft sensor.

If this stored information on the last position of the cylinders is no longer available when restarting, a method for determining the cylinder position is required. Starting methods in which injection and ignition are performed in an uncontrolled fashion at an arbitrary point in time, and the internal combustion engine is set to the desired operating point by means of the engine controller within a few working cycles, are not preferred options in the context of a start-stop strategy owing to the high number of starting processes, because it would be necessary to accept considerable disadvantages with regard to fuel consumption and emissions behaviour, which opposes the basic aim of deactivation in the absence of a demand for power. Furthermore, each individual starting process would take a relatively long time, that is to say would require a number of crankshaft revolutions to achieve synchronization.

The inventors herein have recognized potential disadvantages with the above engine systems. In the case of internal combustion engines with exhaust-gas turbocharging, a start-stop strategy according to which the internal combustion engine is switched off as soon as there is no load demand leads to exhaust gas and also fresh air no longer being supplied to the turbine of the at least one exhaust-gas turbocharger. Thus, the turbine is likewise switched off, i.e. deactivated, when the internal combustion engine is switched off. The rotational speed of the turbine decreases sharply, with the result that, when the internal combustion engine is restarted, the rotor of the turbine may first of all be accelerated in order to be able to generate and make available the desired boost pressure at the compressor side. The response behaviour may be unsatisfactory since the internal combustion engine has to be fired for a number of operating cycles in order to be able to make available on the exhaust side the exhaust gas required for the turbine, so that the compressor power is then available on the intake side.

In one example, the issues described above may be addressed by example system for a supercharged internal combustion engine comprising: an engine coupled to a crankshaft, an intake system including an intake passage for supply of charge air to one or more engine cylinders of the engine, an exhaust-gas discharge system for discharge of exhaust gas, at least one exhaust-gas turbocharger comprising a turbine arranged in the exhaust-gas discharge system and a compressor arranged in the intake system, an electrically driveable compressor arranged in the intake system downstream of the compressor, a bypass line coupled to the intake system for bypassing the electrically driveable compressor, the bypass line forming each of a first junction point with the intake passage, between the electrically driveable compressor and the compressor of the at least one exhaust-gas turbocharger, and a second junction point with the intake passage, downstream of the electrically driveable compressor, a first shut-off element provided in the bypass line, a line coupling the intake system and the exhaust-gas discharge system, the line forming each of a third junction point with the intake passage, downstream of the electrically driveable compressor, and a fourth junction point with the intake passage, upstream of the turbine of the at least one exhaust-gas turbocharger, a second shut-off element provided in the line, a starting device configured to rotate the crankshaft during a starting process. The system further including a controller with computer readable instructions stored on non-transitory memory to: during a fired operating mode in which fuel is injected and ignition is initiated, in response to a lower than threshold load demand, transition the internal combustion engine to a non-fired operating mode in which neither is fuel introduced nor is ignition initiated; and then engine in response to a higher than threshold load demand, start the internal combustion, wherein, the start includes activating the starting device in order to set the crankshaft in rotation, activating the electrically driveable compressor, opening the second shut-off element to open the line to supply charge air from the electrically driveable compressor to the turbine via the line, then firing the internal combustion engine responsive to completion of a synchronization, and in a fired operating mode of the internal combustion engine, stopping the supply of charge air to the turbine using the electrically driveable compressor. In this way, by supplying the turbine with compressed air as a pre-emptive measure when starting the internal combustion engine, the turbine spin-up is expedited before the internal combustion engine is fired again.

In one example, the electrically driveable compressor of the internal combustion engine is used in the context of the starting process or restarting to supply charge air or fresh air to the turbine via a line. For this purpose, a line connects the intake system downstream of the electrically driveable compressor to the exhaust-gas discharge system upstream of the turbine of the at least one exhaust-gas turbocharger. A shut-off element provided in the line is used to open up the line and to block said line.

In this way, by supplying the turbine with charge air as a preparatory measure when starting the internal combustion engine, the rotor of the turbine is accelerated and the rotational speed of the turbine is raised before the internal combustion engine is fired again. This procedure ensures that the boost pressure required for the supercharged mode is available on the intake side from the very first fired operating cycle of the newly started internal combustion engine. Delays resulting from the fact that the turbine has first to be accelerated by the exhaust gas generated in the fired mode of the internal combustion engine are reduced. The technical effect of routing compressed air from the intake manifold to the exhaust turbine is that the supercharging response behaviour is improved, thereby allowing an improved start-stop strategy for engine performance and operator driving experience.

According to the disclosure, the electrically driveable compressor may be an activatable compressor, which is activated when demanded. In addition to the use described above, the electrically driveable compressor may be used whenever there is a demand, including, for example, to assist the exhaust-gas turbocharger in compressing the charge air. The electrically driveable compressor may also be used to generate the boost pressure instead of the exhaust-gas turbocharger, especially in the case of low loads or small charge air quantities.

According to the disclosure, the electrically driveable compressor does not necessarily have to be switched off after starting or in the fired mode of the internal combustion engine. According to the method according to the disclosure, in the fired operating mode of the internal combustion engine, only the supply of charge air to the turbine using the electrically driveable compressor is stopped. In principle, therefore, the electrically driveable compressor may continue to be operated after starting, e.g., in the normal mode of the internal combustion engine, but is then used to compress the charge air and to deliver the charge air in the intake system.

In principle, the crankshaft may be forcibly set in rotation, even without the use of a starting device, when starting, e.g., by closing the clutch and initiating a drag mode or overrun mode of the internal combustion engine. However, this procedure may impact driving comfort because of the occurring and perceptible braking torque. Further, it may be possible to dispense with synchronization of the internal combustion engine, as already mentioned. Injection and the ignition may then take place in an uncontrolled manner at an arbitrary point in time when starting, with the adjustment of the internal combustion engine to the instantaneous operating point by the engine control system being delayed.

Embodiments of the method are provided in which the starting device is activated before the electrically driveable compressor is activated and the line coupling the intake manifold and the exhaust manifold is opened up by opening the shut-off element in order to supply charge air to the turbine. However, embodiments of the method can also be provided in which the electrically driveable compressor is activated and the line is opened up by opening the shut-off element in order to supply charge air to the turbine before the starting device is activated.

The two method variants above take account of the fact that a different time sequence or order of the method steps may be advantageous, depending on the individual case, e.g., the respective internal combustion engine under consideration. In choosing a suitable chronology, the respective intake system or exhaust-gas discharge system, in particular the line lengths, and the charging concept used may be taken into consideration, including, for example, the number of exhaust-gas turbochargers used and the size of the exhaust-gas turbochargers used, in particular the size of the turbine to be accelerated.

Embodiments of the method are provided in which the line is blocked by closing the shut-off element as soon as the internal combustion engine is fired. According to the disclosure, in the fired operating mode of the internal combustion engine, the supply of charge air to the turbine using the electrically driveable compressor may be stopped. This is achieved by closing the shut-off element or blocking the line. In addition, the electrically driveable compressor may be switched off. Embodiments of the method may therefore be provided in which the electrically driveable compressor is deactivated as soon as the internal combustion engine is fired again.

In this context, embodiments of the method are provided in which the bypass line is opened up by opening the shut-off element for the purpose of bypassing the electrically driveable compressor. If the electrically driveable compressor is deactivated, it merely forms a flow resistance for the charge air compressed in the compressor of the exhaust-gas turbocharger, for which reason it may be advantageous to eliminate or circumvent this flow resistance. This purpose is served by the bypass line, which may be opened up by opening the associated shut-off element.

Embodiments of the method are provided in which the charge air supplied to the internal combustion engine is cooled by a charge-air cooler in the fired operating mode of the internal combustion engine. Owing to the compression, the compressed charge air generally also has a higher temperature as well as a higher pressure, for which reason it is advantageous to cool the charge air before entry to the cylinders. The temperature is lowered and the density increased, thereby achieving better charging or a larger fresh cylinder charge.

In this context, embodiments of the method are provided in which the charge air is cooled by a charge-air cooler between the compressor of the at least one exhaust-gas turbocharger and a first junction point between a first end of the bypass line of the electrically driveable compressor, proximal to the turbocharger compressor, and the intake passage. This ensures that the compressed charge air is cooled even if the bypass line for bypassing the electrically driveable compressor is open due to the opening of the associated shut-off element. In the case of a charge-air cooler arranged downstream of the first junction point, this would not be assured, unless a charge-air cooler were arranged downstream of a second junction point between a second end of the bypass line of the electrically driveable compressor, distal to the turbocharger compressor, and the intake passage. In this context, therefore, embodiments of the method may also be provided in which the charge air is cooled by a charge-air cooler downstream of the second junction point.

A charge-air cooler arranged downstream of the second junction point also cools the charge air guided through the electrically driveable compressor and compressed thereby, and does so both when the charge air is compressed in a single stage using the electrically driveable compressor and when the charge air is compressed as part of a multi-stage compression process.

Embodiments of the method are provided in which the line coupling the exhaust passage, upstream of the turbocharger turbine, to the intake passage, downstream of the turbocharger compressor, is used as a recirculation line of an exhaust-gas recirculation arrangement in the fired operating mode of the internal combustion engine. Exhaust-gas recirculation serves for the reduction of untreated nitrogen oxide emissions. The recirculation rate X_{EGR} is determined as X_{EGR}=m_{EGR}/(m_{EGR}+m_{fresh air}), where m_{EGR} is the mass of recirculated exhaust gas and m_{fresh air} is the fresh air supplied.

The internal combustion engine according to the embodiment under consideration uses the line as a recirculation line of an exhaust-gas recirculation arrangement, namely a high-pressure EGR arrangement, in which exhaust gas taken from the exhaust-gas discharge system upstream of the turbine is introduced into the intake system downstream of the compressors.

In the case of a low-pressure EGR arrangement, in contrast, exhaust gas that has already flowed through the turbine is recirculated into the intake system. For this purpose, the low-pressure EGR arrangement comprises a recirculation line which branches off from the exhaust-gas discharge system downstream of the turbine and which opens into the intake system upstream of the compressor. The main advantage of the low-pressure EGR arrangement in relation to a high-pressure EGR arrangement is that the exhaust-gas flow introduced into the turbine during exhaust-gas recirculation is not reduced by the quantity of recirculated exhaust gas. The entire exhaust-gas flow is always available at the turbine for generating an adequately high boost pressure. However, there are countervailing disadvantages of low-pressure EGR. In a low-pressure EGR arrangement, for example, there are often difficulties in providing the high pressure gradient required for high recirculation rates between the exhaust-gas recirculation system and the intake system, whereas this driving pressure gradient may be generated without problems in a high-pressure EGR arrangement by virtue of the high exhaust-gas pressure upstream of the turbine.

Since, within the low-pressure EGR arrangement, exhaust gas is passed through the compressor, the recirculated exhaust gas should be subjected to exhaust-gas aftertreatment, in particular in a particle filter. It is thereby possible to avoid deposits in the compressor, which change the geometry of the compressor, in particular the flow cross sections, and thereby impair the efficiency of the compressor.

Moreover, problems may arise if the temperature of the recirculated hot exhaust gas decreases and condensate forms upstream of the compressor. Condensate and condensate droplets are undesirable and lead to increased noise emissions in the intake system, and possibly to damage of the blades of the at least one compressor impeller. The latter effect is associated with a reduction in efficiency of the compressor. The exhaust-gas quantity recirculated by low-pressure EGR is often limited in order to reduce condensation, and therefore a high-pressure EGR arrangement is often used in addition to the low-pressure EGR arrangement or a high-pressure EGR arrangement is used instead of the low-pressure EGR arrangement.

Embodiments of the internal combustion engine are provided in which the turbine of the at least one exhaust-gas turbocharger is equipped with a variable turbine geometry. A variable turbine geometry increases the flexibility of the supercharging. It permits a continuous adaptation of the turbine geometry to the respective operating point of the internal combustion engine and to the present exhaust-gas mass flow. Here, guide blades for influencing the flow direction are arranged upstream of the impeller of the turbine. In contrast to the impeller blades of the rotating impeller, the guide blades do not rotate with the shaft of the turbine that is to say with the impeller. The guide blades are arranged so as to be stationary but not so as to be completely immovable, rather so as to be rotatable about their axis such that the flow approaching the impeller blades may be influenced.

By contrast, if a turbine has a fixed, invariable geometry, the guide blades are not only stationary but are also completely immovable, that is to say rigidly fixed, if guide blades or a guide device are or is provided at all. In particular, the combination of turbine with variable turbine geometry and compressor with variable compressor geometry makes it possible to achieve high boost pressures even in the presence of very low exhaust-gas flow rates.

Embodiments are therefore also provided in which the compressor of the at least one exhaust-gas turbocharger is equipped with a variable compressor geometry. A variable compressor geometry has proven to be advantageous in particular if only a small exhaust-gas flow rate is conducted through the turbine because, by adjustment of the guide blades, the surge limit of the compressor in the compressor characteristic map may be shifted in the direction of small compressor flows, and thus the compressor is prevented from operating beyond the surge limit. The variable compressor geometry therefore also offers advantages if high exhaust-gas flow rates are branched off upstream of the turbine and recirculated, in order to realize high recirculation rates. If the turbine of the at least one exhaust-gas turbocharger has a variable turbine geometry, the variable compressor geometry may be adapted continuously to the turbine geometry.

Embodiments of the method are provided in which the electrically driveable compressor is smaller than the compressor of the at least one exhaust-gas turbocharger. This is advantageous particularly as regards the object according to the disclosure of the electrically driveable compressor and in the case of embodiments in which the electrically driveable compressor operates as a high-pressure stage as part of a multi-stage compression arrangement.

Embodiments of the method are provided in which only one exhaust-gas turbocharger is provided. Then, it is generally the case that single-stage supercharging or compression takes place during the normal operation of the internal combustion engine. With regard to friction losses and overall efficiency, it is more advantageous to use a single exhaust-gas turbocharger than multiple turbochargers, for which reason the above embodiment has advantages in terms of efficiency.

However, embodiments of the method can may be provided in which the electrically driveable compressor is activated to assist the compressor of the exhaust-gas turbocharger in order to generate a specifiable boost pressure in the intake system downstream of the compressors. Embodiments of the method are provided in which the clutch is opened in a non-fired operating mode of the internal combustion engine in order to avoid a braking torque generated in an overrun mode.

Embodiments of the method are provided in which a fuel injection system and/or an ignition device of the internal combustion engine is/are deactivated in the non-fired operating mode of the internal combustion engine. Embodiments of the method may be provided in which charge air is supplied to the turbine via the line in the non-fired operating mode of the internal combustion engine, using the electrically driveable compressor, in order to ensure a minimum speed of the turbine. In the context of the present disclosure, this procedure too may be regarded as a preparatory measure in respect of the restarting of the internal combustion engine, wherein the rotor of the turbine is not actually accelerated, being, on the contrary, held at the same rotational speed or at a minimum rotational speed until the internal combustion engine is fired again.

In this way, the rotational speed of the turbine falls to a lesser extent, and a minimum rotational speed of the charger shaft may be ensured or maintained. The latter has a further relevant advantage. Specifically, if the rotational speed of the charger shaft falls below a minimum rotational speed, or if the charger shaft even comes to a standstill, the seal of the bearing arrangement of the oil-lubricated charger shaft may leak at the compressor side. Oil leakage at the intake side has severe disadvantages. If oil passes into the intake system, the oil-contaminated fresh charge supplied to the cylinders adversely affects the combustion process, whereby in particular, the untreated particle emissions may greatly increase. The oil may also be deposited on the inner walls of the intake system and impair the flow conditions in the intake system and/or in the compressor, and contaminate a charge-air cooler arranged downstream.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows an example of an internal combustion engine.

FIG. 2 shows a flow chart illustrating an example method that may be implemented for operating an electrically drivable compressor during engine start.

FIG. 3 shows an example operation of the electrically drivable compressor for turbocharger turbine spool up during an engine start.

### DETAILED DESCRIPTION

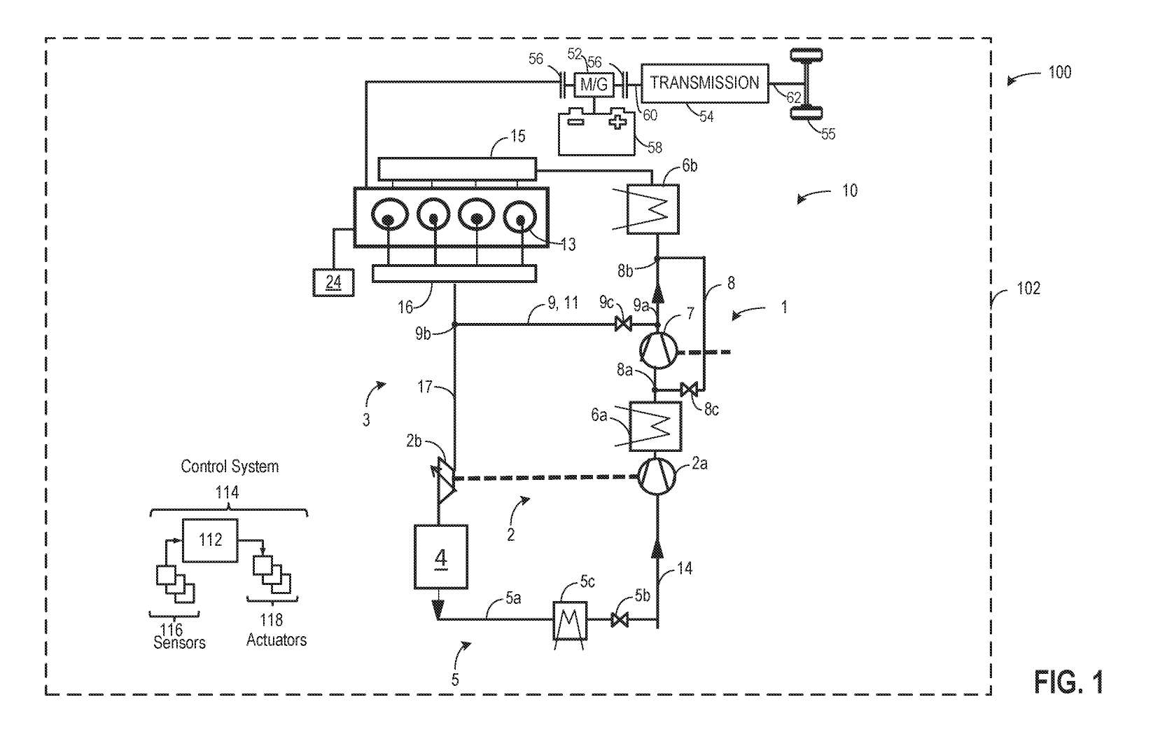

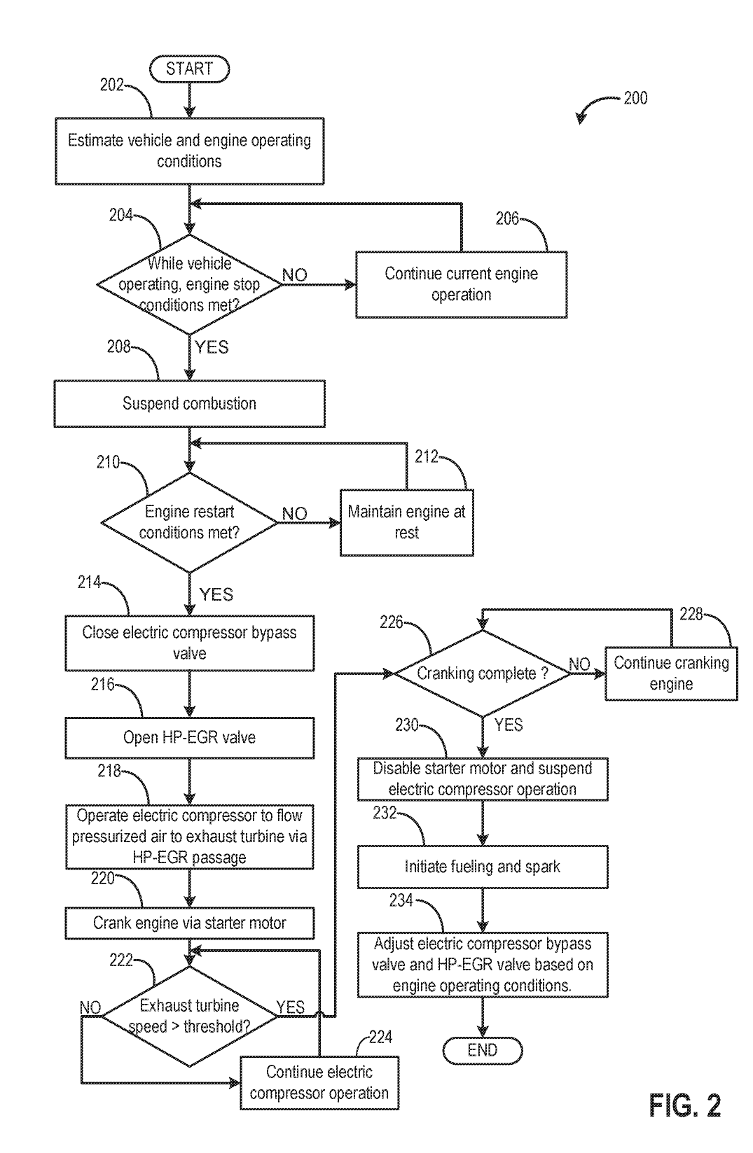

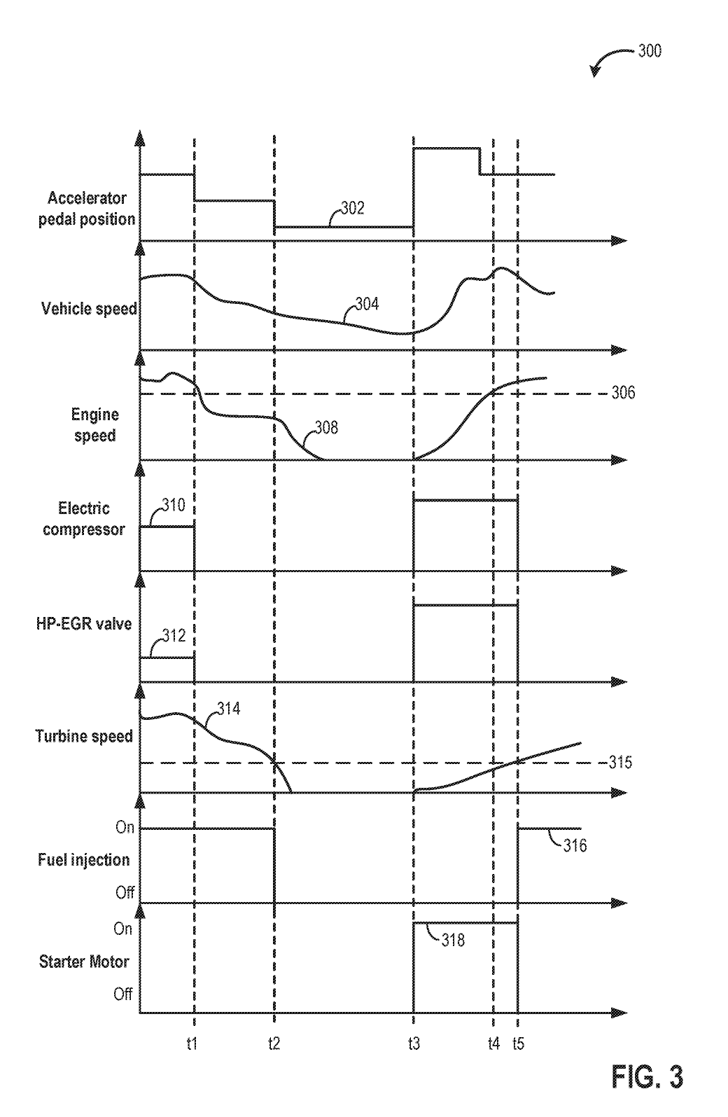

The following description relates to systems and methods for operating an electrically drivable compressor for turbocharger turbine spool up during an engine start following an engine stop while the vehicle is in motion. An internal combustion engine including an electrically drivable compressor is shown in FIG. 1. An engine controller may be configured to perform control routines, such as the example routine of FIG. 2, to operate the electrically drivable compressor during an engine start following an engine stop condition. An example operation of the electrically drivable compressor during the engine start-stop condition is shown in FIG. 3.

FIG. 1 schematically shows a first embodiment of an engine system 100 of the supercharged internal combustion engine 10 included in a vehicle 102. In one example, the engine system 100 may be a diesel engine system. In another example, the engine system 100 may be a gasoline engine system. Engine 10 may be equipped with an exhaust-gas turbocharger 2 which comprises a turbine 2b arranged in an exhaust passage 17 of an exhaust-gas discharge system 3 and a compressor 2a arranged in the intake system 1. The hot exhaust gas expands in the turbine 2b with a release of energy. The compressor 2a compresses the charge air which is supplied to the cylinders via the intake system 1 and the charge-air coolers 6a, 6b provided downstream, as a result of which supercharging of the internal combustion engine 10 is realized. Said internal combustion engine is a four-cylinder in-line engine 10 in which the four cylinders are arranged along the longitudinal axis of the cylinder head that is to say in a line.

Arranged in the intake passage 14 of the intake system 1, downstream of the compressor 2a of the exhaust-gas turbocharger 2, is an electrically driveable compressor 7, which may be connected in series with the compressor 2a of the exhaust-gas turbocharger 2 and may be switched on when required to assist the compressor 2a of the exhaust-gas turbocharger 2 in order to supply the cylinders with sufficient charge air. Electrically drivable compressor 7 may be powered via an on-board energy storage device, which may comprise a battery, capacitor, supercapacitor, etc. The electric air compressor may include a compressor driven by an electric motor.

A bypass line 8 is provided for the purposes of bypassing the electrically driveable compressor 7, which bypass line branches off from the intake system 1, with the formation of each of a first junction point 8a with the intake passage 14, between the electrically driveable compressor 7 and the compressor 2a of the exhaust-gas turbocharger 2, and a second junction point 8b with the intake passage 14, downstream of the electrically driveable compressor 7. In the bypass line 8 there is provided a first shut-off element 8c for opening up and blocking the bypass line 8.

A line 9 may be coupled to the intake passage 14 and the exhaust passage 17, with the formation of each of a third junction point 9a with the intake passage 14, downstream of the electrically driveable compressor 7 and upstream of the second junction point 8b and a fourth junction point 9b with the exhaust passage 17, upstream of the turbine 2b of the exhaust-gas turbocharger 2. Fresh air or charge air coming from the intake system 1 may be supplied to the turbine 2b. In the line 9 there is provided a second shut-off element 9c for opening up and blocking the line 9.

If the internal combustion engine 10 is switched off as part of a start-stop strategy, the internal combustion engine 10 may be restarted when there is a new load demand. The electrically driveable compressor 7 is used in the context of the starting process or of the restarting of the internal combustion engine 10 to supply charge air or fresh air to the turbine 2b via the line 9. Supplying the turbine 2b with charge air as a preparatory measure for starting the internal combustion engine 10 ensures that the rotor of the turbine 2b is accelerated and the rotational speed of the turbine 2b is raised before the internal combustion engine 10 is fired again. It is thereby possible to ensure that the boost pressure required for a supercharged mode is ready as soon as the internal combustion engine 10 is fired.

To start the internal combustion engine 10, the crankshaft is in the present case forcibly set in rotation by a starting device such as a starter motor 24 coupled to the crankshafts to each engine cylinder and, at the same time, the electrically driveable compressor 7 is activated and the line 9 is opened up by opening the second shut-off element 9c. The turbine 2b is then supplied with charge air via the line 9 using the electrically driveable compressor 7. After the turbine 2b reaches a threshold speed and the engine is cranked to an engine idling speed, the internal combustion engine 10 is fired and the line 9 is blocked again by closing the second shut-off element 9c. The electrically driveable compressor 7 is designed as an activatable compressor 7, which is activated when demanded. After the starting process, the electrically driveable compressor 7 may be switched off or may remain activated.

In the fired mode of the internal combustion engine 10, the line 9 may be used as a recirculation line 11 of a high-pressure EGR arrangement, in which exhaust gas is taken from the exhaust-gas discharge system 3 upstream of the turbine 2b and introduced into the intake system 1 downstream of the compressors 2a, 7.

In addition, a low-pressure EGR arrangement is provided, which comprises a recirculation line 5a which branches off from the exhaust passage 17 of the exhaust-gas discharge system 3 downstream of the turbine 2b and which opens into the intake passage 14 of the intake system 1 upstream of the compressor 2a of the exhaust-gas turbocharger 2. A third shut-off element 5b and a cooler 5c are arranged in the recirculation line 5a of the low-pressure EGR arrangement 5.

The exhaust gas which flows through the turbine 2b is subjected to exhaust-gas after-treatment in an exhaust-gas after-treatment system 4 downstream of the turbine 2b prior to the exhaust gas being released to the atmosphere. The exhaust-gas after-treatment system 4 may be a three way catalyst (TWC), NOx trap, various other emission control devices, or combinations thereof. In some embodiments, during operation of the engine 10, the exhaust-gas after-treatment system 4 may be periodically reset by operating at least one cylinder of the engine within a particular air/fuel ratio.

Engine 10 may further include control system 114. Control system 114 is shown receiving information from a plurality of sensors 116 (various examples of which are described herein) and sending control signals to a plurality of actuators 118 (various examples of which are described herein). As one example, sensors 116 may include manifold air pressure sensor, exhaust temperature sensor, exhaust pressure sensor, compressor inlet temperature sensor, compressor inlet pressure sensor, compressor inlet humidity sensor, crankshaft position sensor, pedal position sensor, and engine coolant temperature sensor. Other sensors such as additional pressure, temperature, air/fuel ratio, and composition sensors may be coupled to various locations in engine 10. The actuators 118 may include, for example, first shut-off element 8c coupled to the bypass line 8a, second shut-off element 9c coupled to the line 9 connecting the intake passage 14 to the exhaust passage 17, third shut-off element 5c coupled to the low pressure EGR line, one or more fuel injectors coupled to engine cylinders, spark plugs coupled to engine cylinders, starter motor 24, an actuator of the electrically driven compressor 7. The control system 14 may include a controller 12. The controller 12 may receive input data from the various sensors, process the input data, and trigger various actuators in response to the processed input data based on instruction or code programmed therein corresponding to one or more routines. In one example, based on a higher than threshold torque demand as inferred via the pedal position sensor, the controller may send a signal to the starter motor 24 to crank the engine until the engine reaches a desired engine speed. Also, the controller may send a signal to each of the second shut-off element 9c to completely open the shut-off element 9c, and the actuator coupled to the electrically driven compressor 7 to operate the compressor. By operating the compressor, pressurized ambient air may flow from the engine intake passage 14 to the exhaust passage 17 via the line 9, and the pressurized air may spool up the turbine 2b to a threshold speed prior to initiation of combustion. By spooling up the turbine prior to a supply of exhaust gas, torque output during an engine start following an engine stop may be improved and the time required to reach the desired engine speed may be reduced.

In some examples, vehicle 102 may be a hybrid vehicle with multiple sources of torque available to one or more vehicle wheels 55. In other examples, vehicle 101 is a conventional vehicle with only an engine, or an electric vehicle with only electric machine(s). In the example shown, vehicle 102 includes engine 10 and an electric machine 52. Electric machine 52 may be a motor or a motor/generator. Crankshaft of engine 10 and electric machine 52 are connected via a transmission 54 to vehicle wheels 55 when one or more clutches 56 are engaged. In the depicted example, a first clutch 56 is provided between crankshaft and electric machine 52, and a second clutch 56 is provided between electric machine 52 and transmission 54. Controller 112 may send a signal to an actuator of each clutch 56 to engage or disengage the clutch. Transmission input shaft 60 couples the clutch system 56 (including the first clutch and the second clutch) to the transmission 54 while transmission output shaft 62 coupled the transmission to the vehicle wheels 55. By engaging or disengaging the first clutch 56, it is possible to connect or disconnect the crankshaft of the engine from the transmission 54 and the components connected thereto such as the wheels 55. Similarly, by engaging or disengaging the first clutch 56, it is possible to connect or disconnect crankshaft from electric machine 52 and the components connected thereto, and/or connect or disconnect electric machine 52 from transmission 54 and the components connected thereto. When the clutch is engaged, the engine torque causes the transmission input shaft 60 to rotate and engine torque may be transmitted to the wheels 55 via the transmission 54 and the transmission output shaft 64. Transmission 54 may be a gearbox, a planetary gear system, or another type of transmission. The powertrain may be configured in various manners including as a parallel, a series, or a series-parallel hybrid vehicle.

Electric machine 52 receives electrical power from a traction battery 58 to provide torque to vehicle wheels 55. Electric machine 52 may also be operated as a generator to provide electrical power to charge battery 58, for example during a braking operation.

In this way, the components of FIG. 1 enable a system for a vehicle comprising: a vehicle, including a hybrid vehicle, an engine including one or more cylinders, an intake passage, and an exhaust passage, a starter motor coupled to battery, each of a turbocharger compressor and a motor driven electric compressor coupled to the intake passage, a conduit coupled to the intake passage upstream of the turbocharger compressor and upstream of the electric compressor, the conduit including an electric compressor bypass valve, a turbocharger turbine coupled to the exhaust passage, a higher pressure exhaust gas recirculation (HP-EGR) passage coupling the exhaust passage to the intake passage from upstream of the turbocharger turbine to downstream of the turbocharger compressor, the HP-EGR passage including an EGR valve, and a controller with computer readable instructions stored on non-transitory memory to: responsive to a request for an engine start, close the electric compressor bypass valve, open the HP-EGR valve, crank the engine via the starter motor while operating the electric compressor until a speed of engine rotation reaches a target speed.

FIG. 2 illustrates a first example method 200 that may be implemented for operating an electrically drivable compressor to spool up an exhaust turbine during an engine start condition. Instructions for carrying out method 200 and the rest of the methods included herein may be executed by a controller based on instructions stored on a memory of the controller and in conjunction with signals received from sensors of the engine system, such as the sensors described above with reference to FIG. 1. The controller may employ engine actuators of the engine system to adjust engine operation, according to the methods described below.

At 202, the routine includes estimating and/or measuring engine operating parameters. Parameters assessed may include, for example, engine speed (rotational speed in rpm), engine temperature, engine load, and exhaust temperature. Also, ambient conditions including ambient temperature, pressure, and humidity, manifold pressure and temperature, boost pressure, exhaust air/fuel ratio, etc., may be estimated and/or measured.

At 204, the routine includes determining if conditions are met for the engine to stop even when the vehicle is operating and if engine spin-down may be initiated. A vehicle on engine stop operation may include an engine sailing condition where the vehicle is in motion but no torque is being demanded. In another example, the vehicle on engine stop operation may include an idle stop (also referred to as an automatic stop) where the vehicle is stationary. In both examples, the vehicle is still operating and the engine stops are automatic (e.g., performed without an operator-initiated key-off or other signal to shutdown). Conditions for an engine stop while the vehicle is in motion (also referred to as an engine sailing operation) may include an accelerator pedal tip-out condition when there is no torque demand. As an example, during a downhill travel of the vehicle, the vehicle may continue to be in motion due to inertia without a demand for engine torque or motor torque. In some examples, an engine stop may be executed only when vehicle speed and/or engine speed are lower than a respective threshold speed. The routine may also include determining if engine idle-stop conditions are met. Conditions for engine idle-stop may include engine idling for a longer than threshold duration. For example, engine idling may take place while the vehicle is at a traffic stop when the engine load is below a threshold (such as when the vehicle is stationary). Engine operation at the idling speed for a longer than threshold duration may result in increased fuel usage and increased level of exhaust emissions. Also, the threshold duration may be based on fuel level in the fuel tank. In one example, if the fuel level in the fuel tank is lower than a threshold level, the threshold duration may be decreased such that additional fuel may not be consumed for engine idling.

Engine idle-stop conditions may further include a battery state of charge (SOC) greater than a threshold. The controller may check battery SOC against a pre-set minimum threshold (e.g., 30%) and if it is determined that the battery SOC is at least more that 30% charged, an automatic engine stop may be enabled. Confirming engine idle-stop conditions may further include an indication that a motor of a starter/generator is operation ready.

If it is determined that engine stop conditions are not met, at 206, current engine operations may be continued without initiating the engine stop operation, such as the engine may be maintained running with cylinders combusting fuel. A turbocharger turbine and compressor may be rotated via exhaust gas flowing through the turbine. An electrically driven compressor (such electrically driven compressor 7 in FIG. 1) may be operated as desired to provide boost assist during an increased torque demand. The electrically driven compressor may be coupled to an intake passage downstream of a turbocharger compressor and upstream of a charge air cooler. During conditions when the boost pressure provided by operating the turbocharger (such as intake compressor 2a and exhaust turbine 2b in FIG. 1) is lower than a desired boost pressure, the electrically driven compressor may be operated using energy from an onboard energy storage device to provide the desired boost. The speed and duration of operation of the electric air compressor may be adjusted based on turbocharger speed, and torque demand as estimated via a pedal position sensor. In one example, the speed and duration of operation of the electric air compressor may be increased with an increase in the torque demand and a decrease in turbocharger speed. In another example, the speed and duration of operation of the electric air compressor may be decreased with a decrease in the torque demand and an increase in turbocharger speed.

If it is determined that during vehicle operation, engine stop conditions are met, at 208, combustion may be suspended to stop the engine. In order to suspend combustion, fueling to the engine cylinders may be suspended. Also, the controller may disable spark to each cylinder. Once the combustion is suspended, the engine may spin-down and the engine speed may gradually decrease to zero. The engine may be maintained at rest until restart conditions are met. In one example, the clutch coupling the crankshaft of the engine and the transmission system may be disengaged such that rotational speed of the transmission input shaft and the transmission output shafts may be maintained (as the wheels are continued to be rotated) even if the crankshaft comes to a stop.

At 210, the routine includes determining if engine restart conditions are met. In one example, engine restart conditions following an engine stop during vehicle operation may include an increase in operator-requested torque. In one example, the controller may determine the position of the accelerator pedal, for example via a pedal position sensor, to estimate whether the accelerator pedal has been engaged (such as during a tip-in). In another example, engine restart conditions may include a decrease in vehicle speed to below a threshold speed. Below the threshold speed, in absence of engine torque, the vehicle may come to a rest. As an example, the threshold speed may be 5 Mph.

If it is determined that the engine start conditions have not been met, at 212, the engine may be maintained in the stopped condition with the clutch disengaged, and combustion may not be resumed. If it is determined that engine restart conditions are met, at 214, the controller may send a signal to the bypass valve (such as first shut-off element 8c in FIG. 1) coupled to an electrically driven compressor bypass line (such as bypass line 8 in FIG. 1) to actuate the bypass valve to a completely closed position. By closing the bypass line, the entire volume of ambient air entering the intake passage may be routed via the electrically driven compressor. Also, a throttle coupled to the intake manifold may be opened to a wide open position to increase ambient air flow into the intake manifold.

At 216, the controller may send a signal to a valve (such as valve 5c in FIG. 1) housed in a secondary air line such as a high pressure exhaust gas recirculation passage (such as line 9 in FIG. 1). A first end of the secondary air line may be coupled to an intake passage, upstream of a turbocharger compressor and a second end of the secondary air line may be coupled to an exhaust passage, upstream of the turbocharger turbine. At 218, the electrically driven compressor may be operated to flow pressurized air to the turbine via the HP-EGR passage. The controller may send a signal to the electrically driven compressor actuator to actuate the electrically driven compressor using energy from an energy storage device coupled to the electric booster. As the ambient air entering the intake manifold via the wide open throttle flows through the electric air compressor, the air is pressurized and then the pressurized air is routed to the exhaust passage via the HP-EGR passage. The pressured air flows through the turbine, causing the turbine to start spinning even when exhaust gas supply is not present. By flowing pressurized air through the turbine, turbine spool up may be initiated in response to engine restart conditions being met.

At 220, the controller may send a signal to the starter motor (such as starter motor 26 in FIG. 1) coupled to the engine to start cranking the engine in order to increase engine speed to a target engine speed. The target engine speed may be directly proportional to the operator torque demand, as estimated via the pedal position sensor. The starter motor may be powered via an onboard battery. In one example, the battery may be a traction battery (such as traction battery 58 in FIG. 1) coupled to the electric motor of the hybrid vehicle. In one example, engine cranking via the starter motor may be initiated prior to operating the electrically driven compressor to flow pressurized air via the turbine.

At 222, the routine includes determining if the turbine speed has increased to above a threshold speed. As the pressurized air is routed through the turbine, the turbine speed may steadily increase. The threshold turbine speed may be based on the target engine speed. At the target engine speed, the exhaust gas generated by the engine may be sufficient to spin the turbine at the threshold speed. In one example, the controller may calibrate the threshold turbine speed based on the operator torque demand. The controller may use a look up table to determine the threshold turbine speed, with input being the accelerator pedal position and output being the threshold turbine speed. As an example, with an increase in operator torque demand, the threshold turbine speed may increase, and with a decrease in operator torque demand, the threshold turbine speed may decrease.

If it is determined that the turbine speed is lower than the threshold speed, at 224, operation of the electrically driven compressor may be continued until the compressed air flowing through the exhaust turbine causes the turbine speed to increase to the threshold speed. Also, the engine may be continued to be cranked via the starter motor. If it is determined that the speed of the exhaust turbine is higher than the threshold speed, at 226, the routine includes determining if engine cranking is complete. In one example, engine cranking may be considered to be complete if the engine rotational speed increases to the target engine speed (based on operator torque demand). At the target engine speed, the speed of rotation of the transmission input shaft may correspond to the engine speed such that the engine torque may be transmitted to the wheels for wheel rotated at a desired speed. In another example, engine cranking may be considered to be complete if engine synchronization is complete such that the crankshaft rotation is aligned to a position of the camshaft and the controller is able to detect a position of the engine.

If it is determined that cranking is not completed, at 228, the starter motor may continue to operate in order to crank the engine. If it is determined that cranking is completed, at 230, the controller may send a signal to the starter motor to disable the starter motor. Also, the controller may send a signal to the electrically driven compressor actuator to suspend operation of the electric compressor. The clutch coupling the crankshaft of the engine to the transmission system may be engaged, thereby resuming torque transmission from the engine to the wheels.

At 232, combustion may be started by initiating fueling and spark to the engine cylinders. The controller may send a signal to one or more fuel injectors coupled to the engine cylinders to restart fuel injection to each of the cylinders. Also, the controller may send a signal to the spark plug coupled to each cylinder to enable spark. In one example, even if the turbine speed is lower than the threshold speed, operation of the electric compressor may be suspended and combustion may be initiated upon completion of engine cranking. The exhaust gas generated during combustion may cause the turbine speed to increase to the threshold turbine speed.

Once the engine is rotated by combustion, at 234, an opening of the electrically driven compressor bypass valve may be adjusted based on engine operating conditions such as engine load. In one example, if the engine load increases, the opening of the bypass valve may be decreased to route a higher volume of ambient air via the electrically driven compressor to increase boost pressure. As describe previously, during conditions when the boost pressure provided by operating the turbocharger is lower than a desired boost pressure, the electrically driven compressor may be operated to provide the desired boost. Also, the HP-EGR valve may be opened based on demand for HP-EGR. In one example, if the demand for HP-EGR increases, the opening of the HP-EGR valve may be increased to allow a higher amount of exhaust gas to be recirculated from upstream of the turbine to downstream of the turbocharger compressor. The controller may estimate the opening of the HP-EGR valve based on engine operating conditions including engine speed, engine load, and engine temperature. As an example, the controller may use a look-up table to determine the opening of the HP-EGR valve, with the inputs being each of the engine speed, the engine load, and the engine temperature and the output being HP-EGR valve opening.

In this way, during an engine start via a starter motor following an engine stop, a turbocharger turbine may be rotated with compressed intake air, the compressed intake air compressed by an electric air compressor and supplied to an inlet of the turbine via a secondary airline such as a high pressure exhaust gas recirculation line.

FIG. 3 shows an example operating sequence 300 illustrating operation of an electrically driven compressor during an engine start condition following an automatic stop. The horizontal (x-axis) denotes time and the vertical markers t1-t5 identify significant times in the operation of the electrically driven compressor.

The first plot, line 302, shows a position of an accelerator pedal as estimated via a pedal position sensor. The second plot, line 304, shows a speed of operation of the vehicle. The third plot, line 308, shows variation in engine speed over time as estimated via a crankshaft position sensor. Dashed line 306 shows a target engine speed immediately after engine start following an engine stop. The fourth plot, line 310, shows operation of an electrically driven compressor (such as compressor 7 in FIG. 1) coupled to the intake passage downstream of a turbocharger compressor. The fifth plot, line 312, shows an opening of a valve coupled to a high pressure exhaust gas recirculation line coupled to the exhaust passage, upstream of a turbocharger turbine, and to the intake passage, downstream of the turbocharger compressor. The sixth plot, line 314, shows a speed of rotation of the turbocharger turbine. During engine combustion, exhaust gas may rotate the turbine as it flows through the turbine. Dashed line 315 shows a threshold turbine speed which may be based on the target engine speed 306 immediately after engine start following an engine stop. The seventh plot, line 316, shows injection of fuel to one or more engine cylinders via one or more fuel injectors coupled to the cylinders. The eighth plot, line 318, shows operation of a starter motor to crank the engine. The starter motor is powered via an on-board battery.

Prior to time t1, the accelerator pedal is depressed and the vehicle is propelled via engine torque. A torque demand is estimated as a function of the accelerator pedal position and the boost pressure provided by operation of the turbocharger turbine is not sufficient to meet the estimated torque demand. Hence, the electric compressor is operated to provide the estimated torque demand.

At time t1, in response to the operator tipping-out, the vehicle speed reduces. In response to the tip-out, the engine speed correspondingly reduces. Due to the lower torque demand during the reduced engine speed operation, additional boost pressure generated by the electric compressor is not desired. Also, the HP-EGR is no longer desired for engine dilution. Therefore, at time t1, the electric compressor is disabled and the also the HP-EGR valve is actuated to a closed position.

Between time t1 and t2, the engine continues to operate at the lower engine speed. In response to another accelerator vehicle tip-out, at time t2, an engine stop is initiated to improve fuel efficiency and emissions quality. The inertia of the vehicle is sufficient to maintain vehicle motion even in absence of engine or motor torque. At time t2, engine combustion is suspended by suspending fuel injection and spark to the engine cylinders, and the engine spins down to rest. As the engine spins down, exhaust flow through the turbine decreases and the turbine also spins down, the turbine speed reducing to zero. Between time t2 and t3, each of the engine and the turbine is at rest.

At time t3, in response to an accelerator pedal tip-in, the engine is restarted by cranking via the starter motor. Based on the torque demand at tip-in, the controller estimates a target engine speed 306. The electrically driven compressor is activated to compress ambient air. The controller sends a signal to the actuator coupled to the HP-EGR valve to actuate the valve to a completely open position. The compressed air from the intake manifold flows to the turbine via the HP-EGR line. Between time t3 and t4, as the compressed air flows through the turbine, even before combustion is initiated in the engine, the turbine speed starts increasing. At time t4, it is observed that the engine sped has increased to the target engine speed 306. However, the turbine speed remains below the threshold turbine speed 315. In one example, the controller calibrates the threshold turbine speed 315 corresponding to the target engine speed 306. At the target engine speed 306, the exhaust gas generated by the engine is sufficient to spin the turbine at the threshold speed. The engine is continued to be cranked and the electrically driven compressor is operated until the turbine speed reaches the threshold turbine speed 315.

At time t5, in response to the turbine speed increasing to the threshold turbine speed 315, it is inferred that turbine spool up is complete and the electrically driven compressor is deactivated. The controller sends signal to the starter motor actuator to deactivate the starter motor. The HP-EGR valve is actuated to a closed position. At time t5, the controller sends signals to the fuel injectors coupled to the engine cylinders to reactivate fuel injection. Also, spark is initiated to resume combustion. After time t5, the engine is rotated by combustion of air and fuel and the turbine is rotated via exhaust gas.

In this way, by pre-emptively spinning the exhaust turbine upon an engine start following an engine stop, the time required to provide a desired engine torque following an engine stop is reduced, thereby improving engine performance. By reducing the time required to provide the requested torque, perceivable changes in engine output during an engine start condition is reduced, thereby improving an operator's driving experience. The technical effect of utilizing an electrically driven compressor and a HP-EGR passage to spool up the turbine prior to availability of exhaust gas is that existing engine components may be re purposed for improving engine performance, thereby eliminating the requirement for additional components. Overall, by expediting torque delivery upon an engine start during vehicle operation, engine performance and operator satisfaction may be improved.

An example system for a supercharged internal combustion engine comprises: an engine coupled to a crankshaft, an intake system including an intake passage for supply of charge air to one or more engine cylinders of the engine, an exhaust-gas discharge system for discharge of exhaust gas, at least one exhaust-gas turbocharger comprising a turbine arranged in the exhaust-gas discharge system and a compressor arranged in the intake system, an electrically driveable compressor arranged in the intake system downstream of the compressor, a bypass line coupled to the intake system for bypassing the electrically driveable compressor, the bypass line forming each of a first junction point with the intake passage, between the electrically driveable compressor and the compressor of the at least one exhaust-gas turbocharger, and a second junction point with the intake passage, downstream of the electrically driveable compressor, a first shut-off element provided in the bypass line, a line coupling the intake system and the exhaust-gas discharge system, the line forming each of a third junction point with the intake passage, downstream of the electrically driveable compressor, and a fourth junction point with the intake passage, upstream of the turbine of the at least one exhaust-gas turbocharger, a second shut-off element provided in the line, a starting device configured to rotate the crankshaft during a starting process; and a controller with computer readable instructions stored on non-transitory memory to: during a fired operating mode in which fuel is injected and ignition is initiated, in response to a lower than threshold load demand, transition the internal combustion engine to a non-fired operating mode in which neither is fuel introduced nor is ignition initiated; and then engine in response to a higher than threshold load demand, start the internal combustion, wherein, the start includes activating the starting device in order to set the crankshaft in rotation, activating the electrically driveable compressor, opening the second shut-off element to open the line to supply charge air from the electrically driveable compressor to the turbine via the line, then firing the internal combustion engine responsive to completion of a synchronization, and in a fired operating mode of the internal combustion engine, stopping the supply of charge air to the turbine using the electrically driveable compressor. In any preceding example, additionally or optionally, the synchronization includes a position of the crankshaft being aligned to a position of a camshaft, enabling estimation of an engine position. In any or all of the preceding examples, additionally or optionally, firing the internal combustion engine is further responsive to an engine speed increasing to a target engine speed. In any or all of the preceding examples, additionally or optionally, the starting device is activated before the electrically driveable compressor is activated and the line is opened up by opening the second shut-off element in order to supply charge air to the turbine. In any or all of the preceding examples, additionally or optionally, the electrically driveable compressor is activated and the line is opened up by opening the second shut-off element in order to supply charge air to the turbine before the starting device is activated. In any or all of the preceding examples, additionally or optionally, stopping the supply of charge air to the turbine includes blocking the line by closing the second shut-off element and deactivating the electrically driveable compressor as soon as the internal combustion engine is fired again. In any or all of the preceding examples, additionally or optionally, during the fired operating mode of the internal combustion engine, cooling charge air is supplied to the internal combustion engine by one or more of a first charge-air cooler housed in the intake passage between the compressor of the at least one exhaust-gas turbocharger and the first junction point, and a second charge-air cooler housed in the intake passage downstream of the second junction point. In any or all of the preceding examples, additionally or optionally, the line is used as a high pressure recirculation line of an exhaust-gas recirculation arrangement in the fired operating mode of the internal combustion engine. In any or all of the preceding examples, additionally or optionally, the non-fired operating mode includes disengaging a clutch coupling the internal combustion engine to a transmission system to decouple the engine from the transmission system and vehicle wheels, and deactivating a fuel injection system and/or an ignition device of the internal combustion engine to suspend combustion; and wherein the fired operating mode includes engaging the clutch to transmit engine torque from the engine to the transmission system and the vehicle wheels, and operating the fuel injection system and the ignition device to resume combustion.

Another engine example method comprises: during an engine start, spinning a turbocharger turbine with compressed intake air, the compressed intake air compressed by an electric air compressor and supplied to an inlet of the turbine via a secondary air line. In any preceding example, additionally or optionally, the engine start includes engine spin-up via a starter motor following an engine stop. In any or all of the preceding examples, additionally or optionally, the secondary air line includes a passage with a first end coupled to an intake passage, upstream of a turbocharger compressor and a second end coupled to an exhaust passage, upstream of the turbocharger turbine, the passage including a valve. In any or all of the preceding examples, additionally or optionally, supplying compressed air to the inlet of the turbine includes completely opening the valve. In any or all of the preceding examples, the method further comprises, additionally or optionally, suspending operation of the electric air compressor and closing the valve in response to a speed of the turbocharger turbine increasing to above a threshold speed. In any or all of the preceding examples, the method further comprises, additionally or optionally, initiating fuel injection and spark to one or more engine cylinders and deactivating the starter motor in response to the turbocharger turbine speed increasing to above the threshold speed and an engine speed increasing to a target speed. In any or all of the preceding examples, additionally or optionally, the electric air compressor is coupled to an intake passage, an electric air compressor bypass conduit coupled to the intake passage downstream of an intake compressor and upstream of a charge air cooler, the method further comprising, while supplying compressed air to the inlet of the turbine, closing an electric air compressor bypass valve coupled to the bypass conduit to direct ambient air via the electric air compressor. In any or all of the preceding examples, the method further comprises, additionally or optionally, after initiating fuel injection and spark to one or more engine cylinders, opening the valve to recirculate high pressure exhaust gas from upstream of the turbine to upstream of the turbocharger compressor, wherein an amount of exhaust gas recirculated is based on one or more of engine speed, engine load, and engine temperature.

Another engine example method comprises: a vehicle, including a hybrid vehicle, an engine including one or more cylinders, an intake passage, and an exhaust passage, a starter motor coupled to battery, each of a turbocharger compressor and a motor driven electric compressor coupled to the intake passage, a conduit coupled to the intake passage upstream of the turbocharger compressor and upstream of the electric compressor, the conduit including an electric compressor bypass valve, a turbocharger turbine coupled to the exhaust passage, a higher pressure exhaust gas recirculation (HP-EGR) passage coupling the exhaust passage to the intake passage from upstream of the turbocharger turbine to downstream of the turbocharger compressor, the HP-EGR passage including an EGR valve, and a controller with computer readable instructions stored on non-transitory memory to: responsive to a request for an engine start, close the electric compressor bypass valve, open the HP-EGR valve, crank the engine via the starter motor while operating the electric compressor until a speed of engine rotation reaches a target speed. In any preceding example, additionally or optionally, the request for the engine start includes an increase in the engine torque demand during an engine stop condition when the vehicle is in motion. In any or all of the preceding examples, the method further comprises, additionally or optionally, the controller includes further instructions to: responsive to the speed of engine rotation reaching the target speed, deactivate the electric compressor and initiate each of fuel injection via one or more fuel injectors coupled to the one or more engine cylinders, and spark via spark plugs coupled to the one or more engine cylinders.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, 1-4, 1-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for a supercharged internal combustion engine, comprising:
an engine coupled to a crankshaft;
an intake system including an intake passage for supply of charge air to one or more engine cylinders of the engine;
an exhaust-gas discharge system for discharge of exhaust gas;
at least one exhaust-gas turbocharger comprising a turbine arranged in the exhaust-gas discharge system and a compressor arranged in the intake system;
an electrically driveable compressor arranged in the intake system downstream of the compressor;
a bypass line coupled to the intake system for bypassing the electrically driveable compressor, the bypass line forming each of a first junction point with the intake passage, between the electrically driveable compressor and the compressor of the at least one exhaust-gas turbocharger, and a second junction point with the intake passage, downstream of the electrically driveable compressor, a first shut-off element provided in the bypass line;
a line coupling the intake system and the exhaust-gas discharge system, the line forming each of a third junction point with the intake passage, downstream of the electrically driveable compressor, and a fourth junction point with the intake passage, upstream of the turbine of the at least one exhaust-gas turbocharger, a second shut-off element provided in the line,
a starting device configured to rotate the crankshaft during a starting process; and
a controller with computer readable instructions stored on non-transitory memory to:
during a fired operating mode in which fuel is injected and ignition is initiated,
in response to a lower than threshold load demand, transition the internal combustion engine to a non-fired operating mode in which neither is fuel introduced nor is ignition initiated;
and then engine in response to a higher than threshold load demand, start the internal combustion,
wherein, the start includes activating the starting device in order to set the crankshaft in rotation, activating the electrically driveable compressor, opening the second shut-off element to open the line to supply charge air from the electrically driveable compressor to the turbine via the line, then firing the internal combustion engine responsive to completion of a synchronization, and in a fired operating mode of the internal combustion engine, stopping the supply of charge air to the turbine using the electrically driveable compressor.

2. The system of claim 1, wherein the synchronization includes a position of the crankshaft being aligned to a position of a camshaft, enabling estimation of an engine position.

3. The system of claim 1, wherein firing the internal combustion engine is further responsive to an engine speed increasing to a target engine speed.

4. The system of claim 1, wherein the starting device is activated before the electrically driveable compressor is activated and the line is opened up by opening the second shut-off element in order to supply charge air to the turbine.

5. The system of claim 1, wherein the electrically driveable compressor is activated and the line is opened up by opening the second shut-off element in order to supply charge air to the turbine before the starting device is activated.

6. The system of claim 1, wherein stopping the supply of charge air to the turbine includes blocking the line by closing the second shut-off element and deactivating the electrically driveable compressor as soon as the internal combustion engine is fired again.

7. The system of claim 1, wherein during the fired operating mode of the internal combustion engine, cooling charge air is supplied to the internal combustion engine by one or more of a first charge-air cooler housed in the intake passage between the compressor of the at least one exhaust-gas turbocharger and the first junction point, and a second charge-air cooler housed in the intake passage downstream of the second junction point.

8. The system of claim 1, wherein the line is used as a high pressure recirculation line of an exhaust-gas recirculation arrangement in the fired operating mode of the internal combustion engine.

9. The system of claim 1, wherein the non-fired operating mode includes disengaging a clutch coupling the internal combustion engine to a transmission system to decouple the engine from the transmission system and vehicle wheels, and deactivating a fuel injection system and/or an ignition device of the internal combustion engine to suspend combustion; and wherein the fired operating mode includes engaging the clutch to transmit engine torque from the engine to the transmission system and the vehicle wheels, and operating the fuel injection system and the ignition device to resume combustion.

10. A method, comprising:
during an engine start, spinning a turbocharger turbine with compressed intake air, the compressed intake air compressed by an electric air compressor and supplied to an inlet of the turbine via a secondary air line.

11. The method of claim 10, wherein the engine start includes engine spin-up via a starter motor following an engine stop.

12. The method of claim 11, wherein the secondary air line includes a passage with a first end coupled to an intake passage, upstream of a turbocharger compressor and a second end coupled to an exhaust passage, upstream of the turbocharger turbine, the passage including a valve.

13. The method of claim 12, wherein supplying compressed air to the inlet of the turbine includes completely opening the valve.

14. The method of claim 12, further comprising, suspending operation of the electric air compressor and closing the valve in response to a speed of the turbocharger turbine increasing to above a threshold speed.

15. The method of claim 14, further comprising, initiating fuel injection and spark to one or more engine cylinders and deactivating the starter motor in response to the turbocharger turbine speed increasing to above the threshold speed and an engine speed increasing to a target speed.

16. The method of claim 12, wherein the electric air compressor is coupled to an intake passage, an electric air compressor bypass conduit coupled to the intake passage downstream of an intake compressor and upstream of a charge air cooler, the method further comprising, while supplying compressed air to the inlet of the turbine, closing an electric air compressor bypass valve coupled to the bypass conduit to direct ambient air via the electric air compressor.

17. The method of claim 11, further comprising, after initiating fuel injection and spark to one or more engine cylinders, opening the valve to recirculate high pressure exhaust gas from upstream of the turbine to upstream of the turbocharger compressor, wherein an amount of exhaust gas recirculated is based on one or more of engine speed, engine load, and engine temperature.

18. A system, comprising:
a hybrid vehicle, including:
an engine including one or more cylinders, an intake passage, and an exhaust passage;
a starter motor coupled to battery;
each of a turbocharger compressor and a motor driven electric compressor coupled to the intake passage;
a conduit coupled to the intake passage upstream of the turbocharger compressor and upstream of the electric compressor, the conduit including an electric compressor bypass valve;
a turbocharger turbine coupled to the exhaust passage;
a higher pressure exhaust gas recirculation (HP-EGR) passage coupling the exhaust passage to the intake passage from upstream of the turbocharger turbine to downstream of the turbocharger compressor, the HP-EGR passage including an EGR valve; and
a controller with computer readable instructions stored on non-transitory memory to:
responsive to a request for an engine start,
close the electric compressor bypass valve;
open the HP-EGR valve;
crank the engine via the starter motor while operating the electric compressor until a speed of engine rotation reaches a target speed.

19. The system of claim 18, wherein the request for the engine start includes an increase in the engine torque demand during an engine stop condition when the vehicle is in motion.

20. The system of claim 18, wherein the controller includes further instructions to: responsive to the speed of engine rotation reaching the target speed, deactivate the electric compressor and initiate each of fuel injection via one or more fuel injectors coupled to the one or more engine cylinders, and spark via spark plugs coupled to the one or more engine cylinders.
